(19) United States
(12) Patent Application Publication
(10) Pub. No.: US 2009/0133669 A1
(43) Pub. Date: May 28, 2009

(54) Airflow control apparatus and manufacturing method thereof

(75) Inventors: Hiromitsu Ishihara, Okazaki-shi (JP); Motonobu Hasegawa, Kariya-shi (JP)

Correspondence Address: REED SMITH LLP, Suite 1400, 3110 Fairview Park Drive, Falls Church, VA, 22042, US

(73) Assignee: Aisin Seiki Kabushiki Kaisha

(21) Appl. No.: 12/292,122

(22) Filed: Nov. 12, 2008

(30) Foreign Application Priority Data
Nov. 22, 2007 (JP) 2007-303357

(51) Int. Cl. F02D 9/08

(52) U.S. Cl. 123/337

(57) ABSTRACT

An airflow control apparatus includes a housing for being provided at an air intake passage of an engine and having a passage for allowing an intake air to flow therethrough, a shaft rotatably provided at the housing to extend across the air intake passage, and a valve body provided in the housing to rotate together with the shaft, wherein an opposing surface is provided at the passage to face a circumferential end portion of the valve body when the valve body is in a closing state, and a first inclined surface formed at a portion of the opposing surface extending in an inner circumferential direction of the passage.

### CROSS REFERENCE TO RELATED APPLICATIONS

This application is based on and claims priority under 35 U.S.C. §119 to Japanese Patent Application 2007-303357, filed on Nov. 22, 2007, the entire contents of which is incorporated herein by reference.

### FIELD OF THE INVENTION

The present invention relates to an airflow control apparatus and a manufacturing method thereof.

### BACKGROUND

Air intake pulsation at low to intermediate speeds of a vehicle is strengthened by adjusting an amount of intake air in a timely manner based on a load an engine receives and on an open-close state of an air intake valve. Accordingly, output of the engine is increased because volumetric efficiency is improved. Further, because a flow speed of the intake air is increased, combustion is improved and smoke is decreased. Therefore, fuel efficiency is improved. For adjusting the amount of the intake air, an airflow control apparatus having a housing and a valve body is known. The housing is provided at a hydraulically upper position of an air intake passage relative to the air intake valve. The housing includes a passage allowing a flow of the intake air. The valve body for controlling the amount of the intake air is rotatably accommodated in the housing.

A known airflow control apparatus is disclosed in JP5141540 (which will be hereinbelow referred to as reference 1). The airflow control apparatus according to reference 1 is manufactured by double molding. A molten resin is injected into molds and solidified in order to form a housing. After forming the housing, the molds are moved parallel with the housing. Another resin is injected into a space formed by the molds and the housing, then solidified and shrunk in order to form the valve body. Therefore, a circumferential end portion of the valve body is shaped so as to extend along an inner circumferential surface of the housing. Because the valve body is shrunk during molding, a clearance is provided between the valve body and the housing. Therefore, the valve body is rotatably provided inside the housing.

According to the airflow control apparatus disclosed in reference 1, the circumferential end portion of the valve body is shaped so as to extend along the inner circumferential surface of the housing. For the valve body which is inclined relative to a direction of an air intake flow when in a closing state, when the valve body is attached to the housing as the closing state, the circumferential end portion of the valve body may be fixed at the housing at a position displaced in a rotational direction thereof. In such a case, compared to a case where the valve body is fixed at an original position, the clearance between the valve body and the housing may differ.

Therefore, in a case where a plurality of the airflow control apparatuses having valve bodies, whose circumferential end portions are located at different positions relative to each other in the rotational directions thereof when in the closing states, are provided at the air intake passage for the engine, clearances between the valve bodies and the corresponding housings differ. Therefore, airflow control performance may differ among the airflow control apparatuses.

A need thus exits for an airflow control apparatus which is not susceptible to the drawback mentioned above.

### SUMMARY OF THE INVENTION

According to another aspect of the present invention, an airflow control apparatus, includes a housing provided at an air intake passage of an engine and having a passage for allowing a flow of an intake air, a shaft rotatably provided at the housing to extend across the air intake passage, and a valve body provided in the housing to rotate integrally with the shaft, wherein an opposing surface is provided at the passage to face a circumferential end portion of the valve body when the valve body is in a closing state, and a portion of the opposing surface extending in an inner circumferential direction of the passage is formed in a first inclined surface.

According to a further aspect of the present invention, a method of manufacturing an airflow control apparatus having a housing provided at an air intake passage of an engine and having a passage for allowing a flow of an intake air, the airflow control apparatus having a valve body provided in the housing to rotate integrally with a shaft, the method includes steps of, forming a first space by matching a first mold having a first molding surface for forming a first inclined surface with a second mold having a second molding surface for forming a second inclined surface, thereby forming a shape of the housing having the first inclined surface facing one end of the passage in a longitudinal direction thereof, and the second inclined surface facing the other end of the passage in the longitudinal direction thereof, the housing having an opposing surface provided at the passage and facing a circumferential end portion of the valve body when the valve body is in a closing state, forming the housing by injecting a first molten resin into the first space and solidifying the first resin, unclamping the first mold in a direction of one end of the passage in the longitudinal direction thereof, and the second mold in a direction of the other end of the passage in the longitudinal direction thereof, forming a second space by attaching a third mold having a third molding surface for forming one surface of the valve body from the direction of one end of the passage in the longitudinal direction thereof to the housing and a fourth mold having a fourth molding surface for forming an opposite surface of the valve body from the direction of the other end of the passage in the longitudinal direction thereof to the housing, thereby forming a shape of the valve body by means of the third mold and the fourth mold, the first inclined surface and the second inclined surface forming the circumferential end portion of the valve body, and forming the valve body by injecting a second molten resin into the second space and solidifying the second resin.

According to another aspect of the invention, a method of manufacturing an airflow control apparatus having a housing provided at an air intake passage of an engine and having a passage for allowing a flow of an intake air, and the airflow control apparatus having a valve body provided in the housing to rotate integrally with a shaft, the method includes steps of forming a first space, by matching a first mold having a first molding surface for forming an inclined surface with a second mold not having the molding surface for forming the inclined surface, thereby forming a shape of the housing having the inclined surface facing one end of the passage in a longitudinal direction thereof, and an opposing surface provided at the passage and facing a circumferential end portion of the valve body when the valve body is in a closing state, forming the housing by injecting a first molten resin into the first space and solidifying the first resin, unclamping the first mold in a direction of one end of the passage in the longitudinal direction thereof, forming a second space by attaching, a third mold having a third molding surface for forming one surface of the valve body from the direction of the one end of the passage in the longitudinal direction thereof to the housing, thereby forming the shape of the valve body by means of the second mold for forming an opposite surface of the valve body, the third mold and the inclined surface for forming the circumferential end portion of the valve body, and forming the valve body by injecting a second molten resin into the second space and solidifying the resin

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross-sectional side view illustrating an airflow control apparatus according to a first embodiment;

FIG. 2 is a partially cutaway perspective view illustrating the airflow control apparatus according to the first embodiment;

FIG. 3A is an explanation view illustrating a manner of manufacturing the airflow control apparatus according to the first embodiment;

FIG. 3B is an explanation view illustrating a manner of manufacturing the airflow control apparatus according to the first embodiment;

FIG. 4 is a cross-sectional side view illustrating the airflow control apparatus according to a second embodiment;

FIG. 5 is a cross-sectional side view illustrating the airflow control apparatus according to the second embodiment;

FIG. 6 is a schematic view illustrating a valve according to a fourth embodiment;

FIG. 7 is a cross-sectional side view illustrating the airflow control apparatus according to the fourth second embodiment;

FIG. 8A is an explanation view illustrating a manner of manufacturing the airflow control apparatus according to the fourth embodiment;

FIG. 8B is an explanation view illustrating a manner of manufacturing the airflow control apparatus according to the fourth embodiment;

FIG. 9 is a cross-sectional side view illustrating the airflow control apparatus according to a fifth second embodiment; and

FIG. 10 is an explanation view illustrating an engine according to embodiments.

### DETAILED DESCRIPTION

### First Embodiment

Embodiments of an airflow control apparatus 1 will be described hereinbelow with reference to the attached drawings. According to the first embodiment, the airflow control apparatus 1 is adopted, for example, to an engine 30 of a vehicle.

The airflow control apparatus 1 is provided at an air intake passage 20 of the engine 30 so as to be located between a throttle 60 and an injector 70. The airflow control apparatus 1 controls a speed and a direction of an intake air flowing into the engine 30. As illustrated in FIG. 10, as a piston 31 of the engine 30 moves downward, the intake air to the engine 30 flows into a combustion chamber 32 through the air intake passage 20 via an air intake valve 21. After combustion, exhaust fumes flow through an exhaust passage 40 via an exhaust valve 41. Further, the exhaust fumes are recirculated, if necessary, before emitted out of the engine 30. The airflow control apparatus 1 adjusts the speed and the direction of the intake air conducted to the combustion chamber 32 by adjusting cross-sectional dimensions of the air intake passage 20.

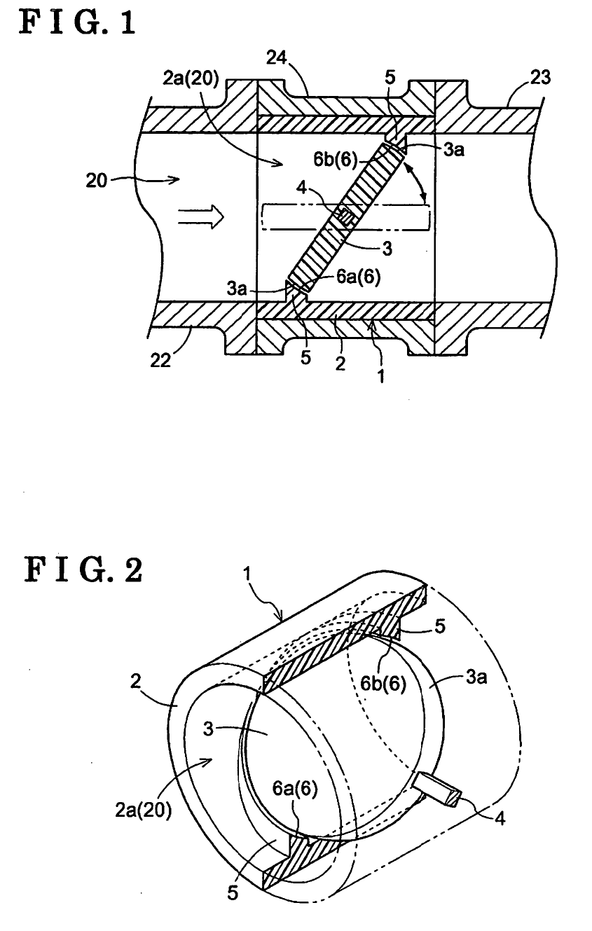

As illustrated in FIGS. 1 and 2, the airflow control apparatus 1 includes a tubular-shaped housing 2 and a valve body 3. The housing 2 is provided at the air intake passage 20 of the engine 30. Inner circumferential surface of the housing 2 forms a passage 2a where the intake air flows through. The valve body 3 is accommodated in the housing 2. The valve body 3 controls the speed and the direction of the air intake flowing through the passage 2a.

A shaft 4 penetrates the housing 2. The valve body 3 is rotatably supported by the shaft 4 relative to the housing 2 so as to adjust the cross-sectional dimensions of the passage 2a of the air intake passage 20. Thickness of the valve body 3 is formed to be substantially even. Further, the valve body 3 is formed in a substantially circular shape when seen in a planar view thereof. A circumferential end portion 3a of the valve body 3 is formed in a circular shape around the shaft 4 in a cross-sectional view seen in a direction where the shaft 4 extends as illustrated in FIG. 1. The valve body 3 is attached to the housing 2 at a position angled at a predetermined degree in a rotational direction thereof from a position where the valve body 3 is provided to be parallel with a longitudinal direction of the passage 2a (“longitudinal” hereinbelow corresponds to a left-right direction of the passage 2a in FIGS. 1, 3A, 3B, 4, 5, 7, 8A, 8B and 9). In such a condition, the passage 2a is in a closed state. The predetermined angle is, for example, from 30° to 60°.

The shaft 4 is, for example, formed in a substantially rod shape whose cross-section is a substantially rectangular shape. The shaft 4 is inserted into and fixed at the valve body 3. The shaft 4 is connected to an actuator 80 in a direction where the shaft 4 extends. The actuator 80 is controlled by a control portion 90 based on a load the engine 30 receives and on a controlling state of the air intake valve 21.

The housing 2 is assembled between a first tubular member 22 and a second tubular member 23. The first and second tubular members 22 and 23 are connected to each other via a connecting member 24. The connecting member 24 is provided so as to surroundingly support the housing 2. Thus, the housing 2 is provided at the air intake passage 20. The passage 2a of the housing 2 allows the flow of the intake air between the first and second tubular members 22 and 23, and thereby the air intake passage 20 is formed.

Opposing surfaces 5 are provided at the inner circumferential surface of the housing 2 that forms the passage 2a. The opposing surfaces 5 include inclined surfaces 6, respectively. When the circumferential end portion 3a of the valve body 3 is located at the position where the passage 2a is in the closed state, the inclined surfaces 6 face the circumferential end portion 3a. Each of the inclined surfaces 6 faces one end of the passage 2a in the longitudinal direction of the passage 2a. More specifically, as described above, the valve body 3 is attached to the housing 2 at a position angled at a predetermined degree in a rotational direction thereof from a position where the valve body 3 is provided to be parallel with a longitudinal direction of the passage 2a. The inclined surfaces 6, which face the circumferential end portion 3a of the valve body 3, include a first inclined surface 6a (which serves as either a first inclined surface or a second inclined surface) and a second inclined surface 6b (which serves as either a first inclined surface or a second inclined surface). The first inclined surface 6a faces one end of the passage 2a in a longitudinal direction thereof (i.e. right end of the passage 2a in FIG. 1). The second inclined surface 6b faces the other end of the passage 2a in the longitudinal direction thereof (i.e. left end of the passage 2a in FIG. 1). Each of the inclined surfaces 6 is formed in a circular shape around a rotational axis of the valve body 3 in a cross-sectional view when seen in a circumferential direction of the passage 2a as illustrated in FIG. 1. In other words, each of the inclined surfaces 6 is formed in a recessed surface that curves along a rotational locus of the circumferential end portion 3a of the valve body 3.

When the valve body 3 is attached to the housing 2 so as to be in a closing state, the circumferential end portion 3a of the valve body 3 may be fixed at a position displaced from an original position in a rotational direction thereof. However, even in such case, the circumferential end portion 3a of the valve body 3 moves along the inclined surfaces 6. Therefore, a clearance between the valve body 3 and the housing 2 is stably obtained.

Accordingly, errors produced when assembling the airflow control apparatus 1 are substantially overcome. The clearance between the circumferential end portion 3a of the valve body 3 and the inner circumferential surface of the housing 2 is substantially constant. Therefore, sealing capability between the valve body 3 and the housing 2 is stably obtained when the valve body 3 is in the closing state. The opposing surfaces 5 according to the first embodiment protrude between 0.2 mm and 0.5 mm from the inner circumferential surface of the housing 2. Protrusion of the opposing surfaces 5 does not influence the flow of the air intake.

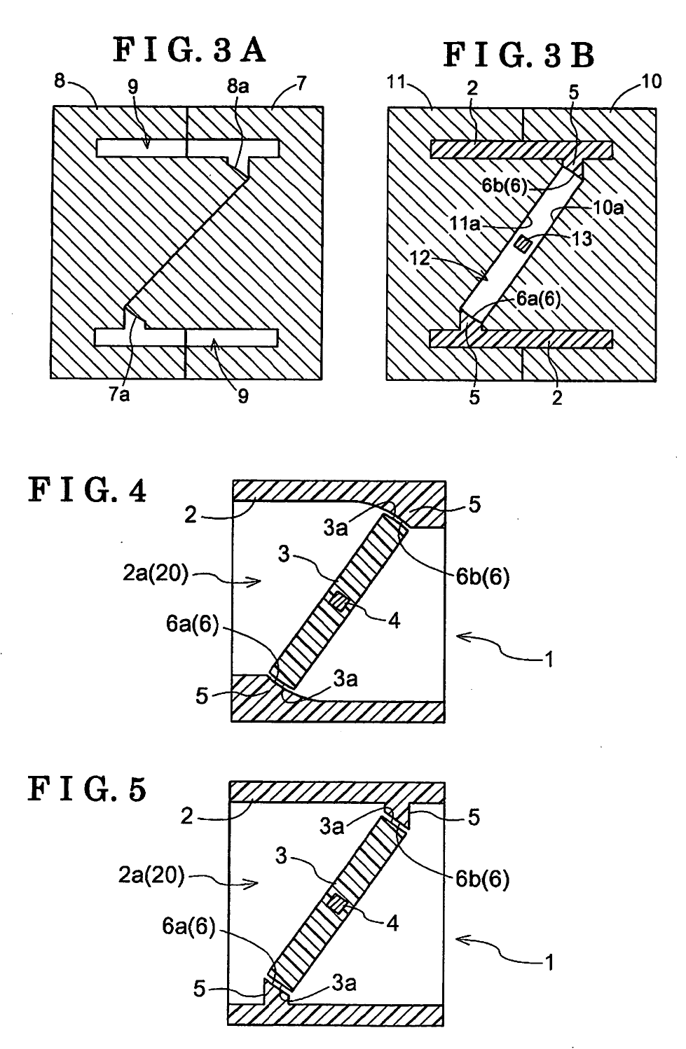

The airflow control apparatus 1 according to the first embodiment is manufactured in the manner shown in FIGS. 3A and 3B. As illustrated in FIG. 3A, a first mold 7 includes a first molding surface 7a that forms the first inclined surface 6a. The first mold 7 forms the inner and outer circumferential surfaces of the housing 2. A second mold 8 includes a second molding surface 8a that forms the second inclined surface 6b. The second mold 8 forms the inner and outer circumferential surfaces of the housing 2. The first and second molds 7 and 8 are matched with each other so as to form a space 9 that forms a shape of the housing 2. When forming the space 9, a core, or the like is provided at a molding surface of the first mold 7 and/or the second mold 8 so that a shaft hole, through which the shaft 4 penetrates, is formed at the housing 2 by an interjection molding (which will be described hereinbelow).

A first molten resin is injected to the space 9 that forms the shape of the housing 2, and is solidified to form the housing 2. For example, polyphenylene sulfide (PPS) is used as the first resin.

After the housing 2 is formed, the first mold 7 is unclamped in a direction in which the first inclined surface 6a faces (i.e. the first mold 7 is unclamped rightward in FIG. 3A). Further, the second mold 8 is unclamped in a direction in which the second inclined surface 6b faces (i.e. the second mold 8 is unclamped leftward in FIG. 3A).

As illustrated in FIG. 3B, a third mold 10 is attached to the housing 2 from the direction in which the first inclined surface 6a faces. The third mold 10 includes a third molding surface 10a. The third molding surface 10a forms one surface of the valve body 3. A fourth mold 11 is attached to the housing 2 from the direction in which the second inclined surface 6b faces. The fourth mold 11 includes a fourth molding surface 11a. The fourth molding surface 11a forms an opposite surface of the valve body 3. The inclined surfaces 6 serve as molding surfaces that form the circumferential end portion 3a of the valve body 3. The third mold 10, the fourth mold 11 and the inclined surfaces 6 form a second space 12 that forms a shape of the valve body 13.

A core 13 whose form is the same as a form of the shaft 4 is provided in the second space 12 that forms a shape of the valve body 3. A second molten resin is injected into the second space 12, solidified and shrunk so as to form the valve body 3. For example, aromatic polyamide (PA6T) is used as the second resin.

After forming the valve body 3, the third mold 10 and the fourth mold 11 are unclamped. The core 13 is pulled out from the valve body 3 and the shaft 4 is inserted into the shaft hole.

According to the above-described manner, the housing 2 and the valve body 3 are easily formed together. Further, the circumferential end portion 3a of the valve body 3 is easily formed into the circular shape that curves along the inclined surface 6.

### Second Embodiment

A second embodiment of the airflow control apparatus 1 will be described hereinbelow. As illustrated in FIG. 4, according to the second embodiment, the opposing surfaces 5 are formed so as to recess relative to the inner circumferential surface of the housing 2. Other structures of the airflow control apparatus 1 are substantially the same as the structures of the airflow control apparatus 1 according to the first embodiment. In the second embodiment also, the clearance between the valve body 3 and the housing 2 when the valve body 3 is in the closing state is stably obtained.

### Third Embodiment

A third embodiment of the airflow control apparatus 1 will be described hereinbelow. As illustrated in FIG. 5, according to the third embodiment, the circumferential end portion 3a of the valve body 3 and the inclined surfaces 6 are formed into plane surfaces in a cross-sectional view when seen in the circumferential direction of the passage 2a as illustrated in FIG. 5. Other structures of the airflow control apparatus 1 are substantially the same as the structures of the airflow control apparatus 1 according to the first embodiment.

According to the third embodiment, in a case where an initial position of the valve body 3 differs when the valve body 3 is attached to the housing 2, the clearance between the circumferential end portion 3a and the inclined surfaces 6 differs. However, even when the initial position of the valve body 3 differs, difference of the clearance between the circumferential end portion 3a and the inclined surfaces 6 when seen in the longitudinal direction of the passage 2a is small. Therefore, sealing capability is improved when the valve body 3 is in the closing state.

### Fourth Embodiment

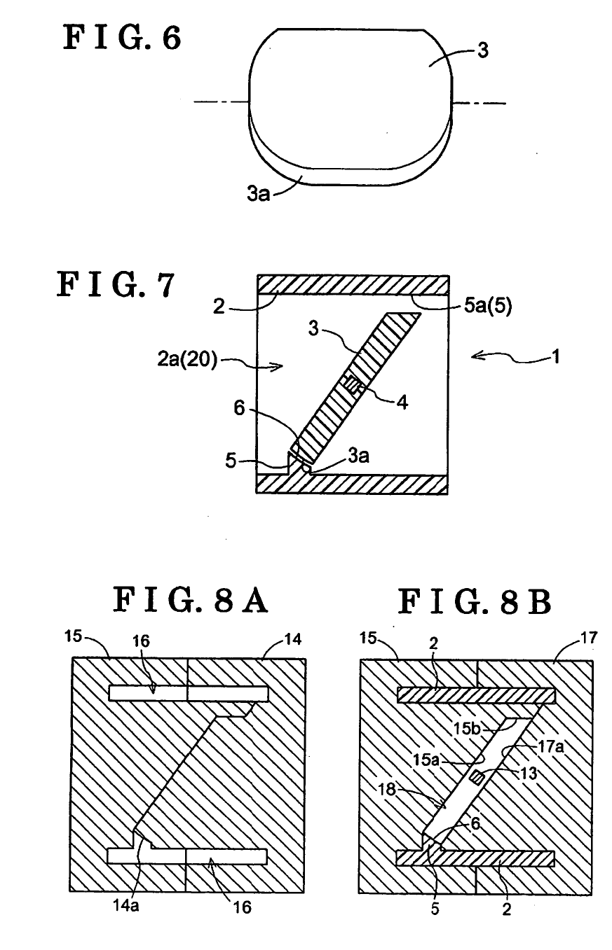

A fourth embodiment of the airflow control apparatus 1 will be described hereinbelow. As illustrated in FIGS. 6 and 7, according to the fourth embodiment, the valve body 3 is formed in a racetrack shape, whose upper portion is cut away when seen in the planar view thereof. Therefore, even when the valve body 3 is in the closing state, the intake air flows through the passage 2a.

As described in the first embodiment, the circumferential end portion 3a of the valve body 3 is formed in the circular shape around the shaft 4 in the cross-sectional view seen in a direction where the shaft 4 extends as illustrated in FIG. 6. The cutaway portion of the circumferential end portion 3a is formed in a plane surface in the cross-sectional view seen in the direction where the shaft 4 extends as illustrated in FIG. 6. Therefore, an opposing surface 5a of the opposing surfaces 5 facing the cutaway portion of the circumferential end portion 3a is not provided with the inclined surface 6 (which serves as either a first inclined surface or a second inclined surface). Other structures of the airflow control apparatus 1 are substantially the same as the structures of the airflow control apparatus 1 according to the first embodiment.

Accordingly, when the valve body 3 is in the closing state, the clearance between the valve body 3 and the housing 2, except for a clearance between the cutaway portion of the circumferential end portion 3a and the housing 2, is stably obtained. Therefore, even when an initial position of the valve body 3 differs in the rotational direction of the valve body 3 when assembling the valve body 3 to the housing 2, a leakage amount of the intake air flowing through the clearance is stabilized.

As illustrated in FIGS. 8A and 8B, the airflow control apparatus 1 according to the fourth embodiment may be manufactured, for example, in a manner described hereinbelow. As illustrated in FIG. 8A, a first mold 14 includes a first molding surface 14a that forms the inclined surface 6. The first mold 14 forms the inner and outer circumferential surfaces of the housing 2. A second mold 15 forms the inner and outer circumferential surfaces of the housing 2. The first and second molds 14 and 15 are matched with each other so as to form a first space 16 that forms the shape of the housing 2. Then, in the same manner as the first embodiment, the housing 2 is formed.

After the housing 2 is formed, the first mold 14 is unclamped in the direction in which the inclined surface 6 faces, while the second mold 15 remains to be attached to the housing 2 (i.e. the first mold 14 only is unclamped rightward in FIG. 8A).

As illustrated in FIG. 8B, a third mold 17 is attached to the housing 2 from the direction in which the inclined surface 6 faces. The third mold 17 includes a third molding surface 17a. The third molding surface 17a forms one surface of the valve body 3. The second mold 15 includes a second molding surface 15b and a fourth molding surface 15a. The fourth molding surface 15a forms the opposite surface of the valve body 3. The second molding surface 15b forms the cutaway portion of the circumferential end portion 3a of the valve body 3. The inclined surface 6 forms the circumferential end portion 3a that is not cut away. Thus, in the same manner as the first embodiment, the second mold 15, the third mold 17 and the inclined surface 6 form a second space 18 that forms the shape of the valve body 3.

Accordingly, the second mold 15 forms both the housing 2 and the valve body 3. In order to form the valve body 3, only the first mold 14 is replaced with the third mold 17 after forming the housing 2. Therefore, the airflow control apparatus 1 is easily manufactured.

### Fifth Embodiment

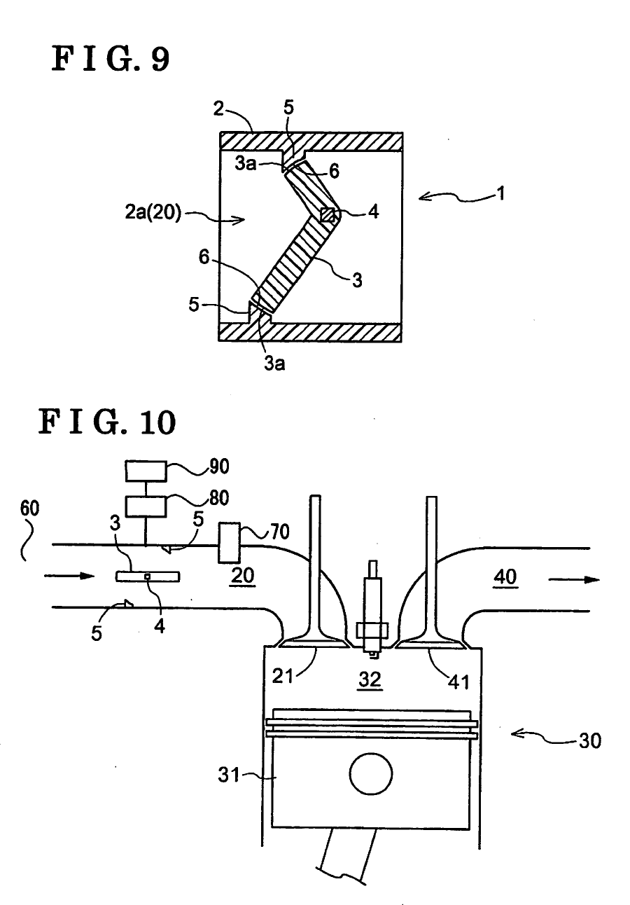

A fifth embodiment of the airflow control apparatus 1 will be described hereinbelow. As illustrated in FIG. 9, according to the fifth embodiment, the valve body 3 is formed in a bent shape in the cross-sectional view seen in a direction where the shaft 4 extends, as illustrated in FIG. 9. The shaft 4 is fixed at the passage 2a at a position displaced from the axis of the passage 2a. Dimension of the passage 2a, where the intake air flows, needs to be the largest when a larger-radial surface of the valve body 3 centering the shaft 4 is located to be substantially parallel with the longitudinal direction of the passage 2a. Therefore, the cross-section of the passage 2a when seen in the longitudinal direction thereof is formed in a substantially elliptical shape or in a substantially rectangular shape. According to the fifth embodiment, the inclined surfaces 6 face only one end of the passage 2a in the longitudinal direction thereof (i.e. the inclined surfaces 6 face only rightward in FIG. 9.) Other structures of the airflow control apparatus 1 are substantially the same as the structures of the airflow control apparatus 1 according to the first embodiment.

Accordingly, clearance between the valve body 3 and the housing 2 when the valve body 3 is in the closing state is stably obtained. Further, the airflow control apparatus 1 according to the fifth embodiment includes the inclined surfaces 6 that face only in one longitudinal direction of the passage 2a. Therefore, when manufacturing the airflow control apparatus 1, only one mold is replaced with another in a manner described in the fourth embodiment.

### Other Embodiments

In the above-described embodiments, the circumferential end portion 3a of the valve body 3 is shaped so as to extend along the inclined surfaces 6. However, the shape of the valve body 3 is not limited to the shapes described above. For example, the circumferential end portion 3a of the valve body 3 may be formed in a plane surface and the inclined surfaces 6 may be formed in a curving recessed surface in the cross-sectional view when seen in the circumferential direction of the passage 2a of the housing 2. Further, the circumferential end portion 3a of the valve body 3 may be formed in a curving protruding surface and the inclined surface 6 may be formed in a plane surface in the cross-sectional view when seen in the circumferential direction of the passage 2a of the housing 2. In such structured airflow control apparatus 1, even when the circumferential end portion 3a of the valve body 3 is attached to the housing 2 at the position displaced from the original position in the rotational direction of the valve body 3, difference of the clearance between the circumferential end portion 3a and the inclined surfaces 6 when seen in a longitudinal direction of the passage 2a is small. Therefore, sealing capability between the valve body 3 and the housing 2 is improved when the valve body 3 is in the closing state.

According to the embodiments, the valve body 3 is formed in the circular shape or in the racetrack shape whose upper part is cut away, when seen in the planar view thereof. However, the shape of the valve body 3 is not limited to the shapes described above. The valve body 3 may be formed in a racetrack shape which does not have a cutaway portion, in an elliptical shape or in a partially cutaway circular shape.

The airflow control apparatus 1 according to the embodiments may be adapted to an engine for a vehicle or an engine for equivalents.

According to the embodiments, the first inclined surfaces 6a face one end of the passage in a longitudinal direction thereof.

According to the embodiments, the first inclined surface 6a is formed into the recessed surface relative to the circumferential end portion 3a of the valve body 3 when the valve body 3 is in the closing state. Accordingly, the rotational locus of the circumferential end portion 3a of the valve body 3 in the vicinity of the first inclined surface 6a is formed in the circular-shape around the rotational axis of the valve body 3. Further, as described above, the first inclined surface 6a is formed into the recessed surface. Therefore, when the circumferential end portion 3a of the valve body 3 is rotated in the vicinity of the first inclined surface 6, the variation of the clearance between the circumferential end portion 3a and the first inclined surface 6a is reduced.

According to the embodiments, the opposing surface 5 further includes the second inclined surface 6b inclining to face the other end of the passage 2a in the longitudinal direction thereof.

According to the embodiments, the second inclined surface 6b is formed into the recessed surface relative to the circumferential end portion 3a of the valve body 3 when the valve body 3 is in the closing state. Accordingly, the rotational locus of the circumferential end portion 3a of the valve body 3 in the vicinity of the second inclined surface 6b is formed in the circular-shape around the rotational axis of the valve body 3. Further, as described above, the second inclined surface 6b is formed into the recessed surface. Therefore, when the circumferential end portion 3a of the valve body 3 is rotated in the vicinity of the second inclined surface 6b, the variation of the clearance between the circumferential end portion 3a and the second inclined surface 6b is reduced.

According to the embodiments, the first inclined surface 6a facing one end of the passage 2a in the longitudinal direction thereof and the second inclined surface 6b facing the other end of the passage 2a in the longitudinal direction thereof are facing each other.

According to the embodiments, the housing 2 and the valve body 3 are made of different resin materials.

According to the embodiments, a first resin of a material of the housing 2 is polyphenylene sulfide (PPS) and a second resin of a material of the valve body 3 is aromatic polyamide (PA6T).

According to the embodiments, the housing 2 is provided between a throttle 60 and an injector 70.

According to the embodiments, the first inclined surface 6a faces the shaft 4.

According to the embodiments, the opposing surface 5 further includes a second inclined surface 6b facing the shaft 4.

According to the embodiments, the first inclined surface 6a and the second inclined surface 6b face each other.

According to the embodiments, the first inclined surface 6a and the second inclined surface 6b are formed to be asymmetric relative to the shaft 4.

According to the embodiments, a method of manufacturing an airflow control apparatus 1 having a housing 2 provided at an air intake passage 20 of an engine 30 and having a passage 2a for allowing a flow of an intake air, the airflow control apparatus 1 having a valve body 3 provided in the housing 2 to rotate integrally with a shaft 4, the method comprising steps of forming a first space 9 by matching a first mold 7 having a first molding surface 7a for forming a first inclined surface 6a with a second mold 8 having a second molding surface 8a for forming a second inclined surface 6b, thereby forming a shape of the housing 2 having the first inclined surface 6a facing one end of the passage 2a in a longitudinal direction thereof, and the second inclined surface 6b facing the other end of the passage 2a in the longitudinal direction thereof, the housing 2 having an opposing surface 5 provided at the passage 2a and facing a circumferential end portion 3a of the valve body 3 when the valve body 3 is in a closing state, forming the housing 2 by injecting a first molten resin into the first space 9 and solidifying the first resin, unclamping the first mold 7 in a direction of one end of the passage 2a in the longitudinal direction thereof, and the second mold 8 in a direction of the other end of the passage 2a in the longitudinal direction thereof, forming a second space 12 by attaching a third mold 10 having a third molding surface 10a for forming one surface of the valve body 3 from the direction of one end of the passage 2a in the longitudinal direction thereof to the housing 2 and a fourth mold 11 having a fourth molding surface 11a for forming an opposite surface of the valve body 3 from the direction of the other end of the passage 2a in the longitudinal direction thereof to the housing 2, thereby forming a shape of the valve body 3 by means of the third mold 10 and the fourth mold 11, the first inclined surface 6a and the second inclined surface 6b forming the circumferential end portion 3a of the valve body 3, and forming the valve body 3 by injecting a second molten resin into the second space 12 and solidifying the second resin. Accordingly, in order to form the valve body 3, the first and second inclined surfaces 6a and 6b of the housing 2 is used as the molding surfaces defining the shape of the circumferential end portion 3a of the valve body 3. Therefore, the circumferential end portion 3a of the valve body 3 is easily formed so as to extend along the first and second inclined surfaces 6a and 6b. In other words, the already-formed housing 2 functions as a part of a mold for forming the shape of the valve body 3. Therefore, structures of the mold are simplified. Further, the shape of the circumferential end portion 3a of the valve body 3 and that of the first and second inclined surface 6a and 6b are substantially the same and the clearance therebetween is reduced. Therefore, when the valve body 3 is in the closing state, the intake air sealing capability is improved.

According to the embodiments, the first resin is polyphenylene sulfide (PPS).

According to the embodiments, the second resin is aromatic polyamide (PA6T).

According to the embodiments, a method of manufacturing an airflow control apparatus 1 having a housing 2 provided at an air intake passage 20 of an engine 30 and having a passage 2a for allowing a flow of an intake air, and the airflow control apparatus 1 having a valve body 3 provided in the housing 2 to rotate integrally with a shaft 4, the method comprising steps of forming a first space 16, by matching a first mold 14 having a first molding surface 14a for forming an inclined surface 6 with a second mold 15 not having the molding surface for forming the inclined surface 6, thereby forming a shape of the housing 2 having the inclined surface 6 facing one end of the passage 2a in a longitudinal direction thereof, and an opposing surface 5 provided at the passage 2a and facing a circumferential end portion 3a of the valve body 3 when the valve body 3 is in a closing state, forming the housing 2 by injecting a first molten resin into the first space 16 and solidifying the first resin, unclamping the first mold 14 in a direction of one end of the passage 2a in the longitudinal direction thereof, forming a second space 18 by attaching, a third mold 17 having a third molding surface 17a for forming one surface of the valve body 3 from the direction of the one end of the passage 2a in the longitudinal direction thereof to the housing 2, thereby forming the shape of the valve body 3 by means of the second mold 15 for forming an opposite surface of the valve body 3, the third mold 17 and the inclined surface 6 for forming the circumferential end portion 3a of the valve body 3, and forming the valve body 3 by injecting a second molten resin into the second space 12 and solidifying the resin.

According to the embodiments, the first resin is PPS (polyphenylene sulfide).

According to the embodiments, the second resin is PA6T (aromatic polyamide).

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. An airflow control apparatus, comprising:
a housing adapted to be provided at an air intake passage of an engine and having a passage for allowing an intake air to flow therethrough;
a shaft rotatably provided at the housing to extend across the air intake passage;
a valve body provided in the housing for rotation with the shaft;
an opposing surface provided at the passage to face a circumferential end portion of the valve body when the valve body is in a closing state; and
a first inclined surface formed at a portion of the opposing surface extending in an inner circumferential direction of the passage.

2. The airflow control apparatus according to claim 1, wherein the first inclined surface faces one end of the passage in a longitudinal direction thereof.

3. The airflow control apparatus according to claim 1, wherein the first inclined surface is formed into a recessed surface relative to the circumferential end portion of the valve body when the valve body is in the closing state.

4. The airflow control apparatus according to claim 1, wherein the opposing surface further includes a second inclined surface inclining to face the other end of the passage in a longitudinal direction thereof.

5. The airflow control apparatus according to claim 4, wherein the second inclined surface is formed into a recessed surface relative to the circumferential end portion of the valve body when the valve body is in the closing state.

6. The airflow control apparatus according to claim 5, wherein the first inclined surface facing one end of the passage in the longitudinal direction thereof and the second inclined surface facing the other end of the passage in the longitudinal direction thereof are facing each other.

7. The airflow control apparatus according to claim 1, wherein the housing and the valve body are made of different resin materials.

8. The airflow control apparatus according to claim 7, wherein a first resin of a material of the housing is polyphenylene sulfide (PPS) and a second resin of a material of the valve body is aromatic polyamide (PA6T).

9. The airflow control apparatus according to claim 1, wherein the housing is provided between a throttle and an injector.

10. The airflow control apparatus according to claim 1, wherein the first inclined surface faces the shaft.

11. The airflow control apparatus according to claim 10, wherein the opposing surface further includes a second inclined surface facing the shaft.

12. The airflow control apparatus according to claim 11, wherein the first inclined surface and the second inclined surface face each other.

13. The airflow control apparatus according to claim 11, wherein the first inclined surface and the second inclined surface are formed to be asymmetric relative to the shaft.

14. A method of manufacturing an airflow control apparatus having a housing adapted to be provided at an air intake passage of an engine and having a passage for allowing an intake air to flow therethrough, the airflow control apparatus having a valve body provided in the housing to rotate together with a shaft, the method comprising the steps of:
forming a first space by matching a first mold having a first molding surface for forming a first inclined surface with a second mold having a second molding surface for forming a second inclined surface, thereby forming a shape of the housing having the first inclined surface facing one end of the passage in a longitudinal direction thereof, and the second inclined surface facing the other end of the passage in the longitudinal direction thereof, the housing having an opposing surface provided at the passage and facing a circumferential end portion of the valve body when the valve body is in a closing state;
forming the housing by injecting a first molten resin into the first space and solidifying the first resin;
unclamping the first mold in a direction of one end of the passage in the longitudinal direction thereof, and the second mold in a direction of the other end of the passage in the longitudinal direction thereof;
forming a second space by attaching a third mold having a third molding surface for forming one surface of the valve body from the direction of one end of the passage in the longitudinal direction thereof to the housing and a fourth mold having a fourth molding surface for forming an opposite surface of the valve body from the direction of the other end of the passage in the longitudinal direction thereof to the housing, thereby forming a shape of the valve body by means of the third mold and the fourth mold, the first inclined surface and the second inclined surface forming the circumferential end portion of the valve body; and
forming the valve body by injecting a second molten resin into the second space and solidifying the second resin.

15. The method according to claim 14, wherein the first resin is polyphenylene sulfide (PPS).

16. The method according to claim 14, wherein the second resin is aromatic polyamide (PA6T).

17. A method of manufacturing an airflow control apparatus having a housing adapted to be provided at an air intake passage of an engine and having a passage for allowing an intake air to flow therethrough, the airflow control apparatus having a valve body provided in the housing to rotate integrally with a shaft, the method comprising the steps of:
forming a first space, by matching a first mold having a first molding surface for forming an inclined surface with a second mold not having the molding surface for forming the inclined surface, thereby forming a shape of the housing having the inclined surface facing one end of the passage in a longitudinal direction thereof, and an opposing surface provided at the passage and facing a circumferential end portion of the valve body when the valve body is in a closing state;
forming the housing by injecting a first molten resin into the first space and solidifying the first resin;
unclamping the first mold in a direction of one end of the passage in the longitudinal direction thereof;
forming a second space by attaching, a third mold having a third molding surface for forming one surface of the valve body from the direction of the one end of the passage in the longitudinal direction thereof to the housing, thereby forming the shape of the valve body by means of the second mold for forming an opposite surface of the valve body, the third mold and the inclined surface for forming the circumferential end portion of the valve body; and
forming the valve body by injecting a second molten resin into the second space and solidifying the resin.

18. The method according to claim 17, wherein the first resin is PPS (polyphenylene sulfide).

19. The method according to claim 17, wherein the second resin is PA6T (aromatic polyamide).
